(19) United States
(12) Patent Application Publication
(10) Pub. No.: US 2016/0344670 A1
(43) Pub. Date: Nov. 24, 2016

(54) FORWARDING MESSAGES IN A COMMUNICATION NETWORK

(71) Applicants: Xin WU, San Diego, CA (US); Zhilong YANG, San Diego, CA (US); Yingqian YANG, San Diego, CA (US); QUALCOMM INCORPORATED, San Diego, CA (US)

(72) Inventors: Xin Wu, Shanghai (CN); Zhilong Yang, Shanghai (CN); Yingqian Yang, Shanghai (CN)

(21) Appl. No.: 15/111,440

(22) PCT Filed: Jan. 17, 2014
(86) PCT No.: PCT/CN2014/070794

§ 371 Date: Jul. 13, 2016

(51) Int. Cl. H04L 12/58; H04L 29/08

(52) U.S. Cl. CPC H04L 51/14; H04L 67/2871

(57) ABSTRACT

A network device can implement functionality to intelligently re-transmit a broadcast message or a multicast message in a communication network to minimize duplicate retransmissions in the communication network. In response to receiving a message for forwarding in the communication network, the network device can determine whether the message includes a first indicator in a predefined field. The first indicator may indicate that a central coordinator of the communication network has previously forwarded the message. The network device can re-transmit the message to another network device connected in the downstream path, if the message includes the first indicator. The network device can re-transmit the message to the central coordinator or an upper-level proxy network device via an upstream path of the communication network, if the message does not include the first indicator.

### BACKGROUND

Embodiments of the inventive subject matter generally relate to the field of communication networks and, more particularly, to forwarding messages in a communication network.

Electric transmission and distribution lines are typically used for providing electric power from generators to buildings, residences, and other components of a city's infrastructure. The electric power may be transmitted over the transmission lines at a high voltage, and may be distributed to buildings and other structures at much lower voltages using electric power lines. Besides providing electric power, electric power lines can also be used to implement powerline communications in both indoor and outdoor environments. Powerline communications can provide another communication medium for connecting various network nodes together in local and wide area networks.

### SUMMARY

Various embodiments for forwarding messages in a communication network are disclosed. In some embodiments, a method comprises: receiving a message at a first network device for forwarding in a first communication network; determining whether to forward the message based, at least in part, on a first predefined field in the message; and in response to determining to forward the message, determining whether to forward the message via an upstream path or a downstream path with respect to a central coordinator in the first communication network based, at least in part, on a second predefined field in the message, wherein the second predefined field indicates whether the central coordinator has previously forwarded the message.

In some embodiments, said determining whether to forward the message via the upstream path or the downstream path comprises determining to forward the message via the downstream path in the first communication network in response to determining that the second predefined field includes a first indicator; and determining to forward the message via the upstream path in the first communication network in response to determining that the second predefined field includes a second indicator.

In some embodiments, the first indicator indicates that the central coordinator previously received the message from a second network device of the first communication network, or the first indicator indicates that the central coordinator generated the message.

In some embodiments, the second indicator indicates that the central coordinator has not received the message from a second network device of the first communication network, or the second indicator indicates that the central coordinator did not generate the message.

In some embodiments, determining whether to forward the message from the first network device comprises comparing a first device identifier in the first predefined field against a second device identifier associated with a second network device that is directly connected with the first network device; determining to forward the message in the first communication network in response to determining that the first device identifier in the first predefined field matches the second device identifier associated with the second network device; and discarding the message at the first network device in response to determining that the first device identifier in the first predefined field does not match the second device identifier associated with the second network device.

In some embodiments, in response to determining that the first device identifier in the first predefined field matches the second device identifier associated with the second network device, the method further comprises determining to transmit the message via the downstream path of the first communication network in response to determining that the second predefined field includes a first indicator; and determining to transmit the message via the upstream path of the first communication network in response to determining that the second predefined field includes a second indicator.

In some embodiments, in response to determining to transmit the message via the upstream path of the first communication network, the method further comprises transmitting the message from the first network device to a proxy network device associated with the first network device, wherein the proxy network device is configured to forward the message to the central coordinator; or transmitting the message from the first network device directly to the central coordinator.

In some embodiments, in response to determining to transmit the message via the downstream path of the first communication network, the method further comprises determining that the first network device is a proxy network device for a second network device of the first communication network; and determining whether the second network device generated the message based, at least in part, on comparing a device identifier associated with the second network device and a source identifier included in the message.

In some embodiments, the method further comprises transmitting the message from the first network device to the second network device in response to determining that the second network device did not generate the message; and determining not to transmit the message to the second network device in response to determining that the second network device generated the message.

In some embodiments, in response to receiving the message at the first network device from a second network device of the first communication network, the method further comprises, prior to transmitting the message from the first network device to a third network device in the first communication network, updating the first predefined field of the message to include a device identifier associated with the first network device; and updating a third predefined field of the message to indicate that the message was previously forwarded in the first communication network.

In some embodiments, in response to receiving the message at the first network device from a second network device of a second communication network, the method further comprises, prior to transmitting the message from the first network device to a third network device in the first communication network, updating the first predefined field of the message to include a predetermined value that is different from a device identifier associated with the first network device; and updating a third predefined field of the message to indicate that the message was not previously forwarded in the first communication network.

In some embodiments, said receiving the message at the first network device for forwarding in the first communication network comprises one of: receiving the message at the first network device from a second network device of the first communication network; receiving the message at the first network device from a third network device of a second communication network; or generating the message at the first network device.

In some embodiments, a method comprises: receiving a message at a central coordinator of a communication network for forwarding in the communication network; determining whether to forward the message in the communication network based, at least in part, on a first predefined field in the message; in response to determining to forward the message, updating a second predefined field to include a first indicator in the message to indicate that central coordinator received the message; and transmitting the message including the first indicator to a first network device that is directly connected with the central coordinator.

In some embodiments, said determining whether to forward the message comprises comparing a first device identifier in the first predefined field against a second device identifier associated with a downstream network device, wherein the downstream network device is directly connected with the first network device via a downstream path of the communication network; determining to forward the message in response to determining that the first device identifier in the first predefined field matches the second device identifier associated with the downstream network device; and discarding the message at the central coordinator in response to determining that the first device identifier in the first predefined field does not match the second device identifier associated with the downstream network device.

In some embodiments, the method further comprises identifying a plurality of network devices of the communication network that established a direct communication link with the central coordinator; wherein said transmitting the message including the first indicator to the first network device comprises transmitting the message including the first indicator to the plurality of network devices that established the direct communication link with the central coordinator.

In some embodiments, receiving the message at the central coordinator for forwarding in the communication network comprises one of: receiving the message at the central coordinator from a second network device of the communication network; receiving the message at the central coordinator from a third network device of another communication network; or generating the message at the central coordinator.

In some embodiments, a first network device comprises: a processor; and a communication unit coupled with the processor, the communication unit configured to: receive a message for forwarding in a first communication network; determine whether to forward the message based, at least in part, on a first predefined field in the message; and in response to determining to forward the message, determine whether to forward the message via an upstream path or a downstream path with respect to a central coordinator in the first communication network based, at least in part, on a second predefined field in the message, wherein the second predefined field indicates whether the central coordinator has previously forwarded the message.

In some embodiments, the communication unit configured to determine whether to forward the message via the upstream path or the downstream path comprises the communication unit configured to forward the message via the downstream path in the first communication network in response to determining that the second predefined field includes a first indicator; and forward the message via the upstream path in the first communication network in response to determining that the second predefined field includes a second indicator.

In some embodiments, the first indicator indicates that the central coordinator previously received the message from an additional network device of the first communication network; and the second indicator indicates that the central coordinator has not received the message from an additional network device of the first communication network.

In some embodiments, the communication unit configured to determine whether to forward the message comprises the communication unit configured to compare a first device identifier in the first predefined field against a second device identifier associated with a second network device that is directly connected with the first network device; determine to forward the message in the first communication network in response to determining that the first device identifier in the first predefined field matches the second device identifier associated with the second network device; and discard the message at the first network device in response to determining that the first device identifier in the first predefined field does not match the second device identifier associated with the second network device.

In some embodiments, in response to determining to transmit the message via the upstream path of the first communication network, the communication unit is further configured to transmit the message from the first network device to a proxy network device associated with the first network device, wherein the proxy network device is configured to forward the message to the central coordinator; or transmit the message from the first network device directly to the central coordinator.

In some embodiments, in response to determining to transmit the message via the downstream path of the first communication network, the communication unit is further configured to determine that the first network device is a proxy network device for a second network device of the first communication network; and determine whether the second network device generated the message based, at least in part, on comparing a device identifier associated with the second network device and a source identifier included in the message.

In some embodiments, the communication unit is further configured to transmit the message from the first network device to the second network device in response to determining that the second network device did not generate the message; and determine not to transmit the message to the second network device in response to determining that the second network device generated the message.

In some embodiments, in response to receiving the message at the first network device from a second network device of the first communication network, the communication unit is further configured to, prior to transmitting the message from the first network device to a third network device in the first communication network, update the first predefined field of the message to include a device identifier associated with the first network device; and update a third predefined field of the message to indicate that the message was previously forwarded in the first communication network.

In some embodiments, in response to receiving the message at the first network device from a second network device of a second communication network, the communication unit is further configured to, prior to transmitting the message from the first network device to a third network device in the first communication network, updating the first predefined field of the message to include a predetermined value that is different from a device identifier associated with the first network device; and updating a third predefined field of the message to indicate that the message was not previously forwarded in the first communication network.

In some embodiments, a non-transitory machine-readable storage medium having machine executable instructions stored therein, the machine executable instructions comprises instructions to: receive a message at a first network device for forwarding in a communication network; determine whether to forward the message based, at least in part, on a first predefined field in the message; and in response to determining to forward the message, determine whether to forward the message via an upstream path or a downstream path with respect to a central coordinator in the communication network based, at least in part, on a second predefined field in the message, wherein the second predefined field indicates whether the central coordinator has previously forwarded the message.

In some embodiments, said instructions to determine whether to forward the message via the upstream path or the downstream path comprise instructions to forward the message via the downstream path in the communication network in response to determining that the second predefined field includes a first indicator, wherein the first indicator indicates that the central coordinator previously forwarded the message; and forward the message via the upstream path in the communication network in response to determining that the second predefined field includes a second indicator, wherein the second indicator indicates that the central coordinator has not previously forwarded the message.

In some embodiments, said instructions to determine whether to forward the message comprise instructions to compare a first device identifier in the first predefined field against a second device identifier associated with a second network device that is directly connected with the first network device; determine to forward the message in the communication network in response to determining that the first device identifier in the first predefined field matches the second device identifier associated with the second network device; and discard the message at the first network device in response to determining that the first device identifier in the first predefined field does not match the second device identifier associated with the second network device.

In some embodiments, in response to determining to transmit the message via the upstream path of the communication network, said instructions comprise instructions to transmit the message from the first network device to a proxy network device associated with the first network device, wherein the proxy network device is configured to forward the message to the central coordinator; or transmit the message from the first network device directly to the central coordinator.

In some embodiments, in response to determining to transmit the message via the downstream path of the communication network, said instructions comprise instructions to determine that the first network device is a proxy network device for a second network device of the communication network; transmit the message from the first network device to the second network device in response to determining that a device identifier associated with the second network device does not match a source identifier included in the message; and determine not to transmit the message to the second network device in response to determining that the device identifier associated with the second network device matches the source identifier included in the message.

### BRIEF DESCRIPTION OF THE DRAWINGS

The present embodiments may be better understood, and numerous objects, features, and advantages made apparent to those skilled in the art by referencing the accompanying drawings.

FIG. 1 is an example block diagram including a mechanism for forwarding messages in a communication network;

FIG. 2 is an example conceptual diagram illustrating a mechanism for forwarding messages in a communication network;

FIG. 3 is a flow diagram illustrating example operations of a network device for forwarding messages in a communication network;

FIG. 4 is a flow diagram illustrating example operations of a central coordinator for forwarding messages in a communication network;

FIG. 5 is a flow diagram illustrating example operations for forwarding messages in a communication network;

FIG. 6 is a continuation of FIG. 5 and also illustrates example operations for forwarding messages in a communication network; and

FIG. 7 is a block diagram of one embodiment of an electronic device including a mechanism for forwarding messages in a communication network.

### DESCRIPTION OF EMBODIMENT(S)

The description that follows includes exemplary systems, methods, techniques, instruction sequences, and computer program products that embody techniques of the present inventive subject matter. However, it is understood that the described embodiments may be practiced without these specific details. For instance, although examples refer to forwarding messages in a powerline communication network (e.g., a network that implements HomePlug® GreenPHY protocols), embodiments are not so limited. In other embodiments, techniques for forwarding messages may be implemented in communication networks that implement other suitable wired communication protocols (e.g., Ethernet, multimedia over coax alliance (MoCA), HomePlug AV/AV2, etc.) or wireless communication protocols (e.g., wireless local area network protocols, such as IEEE 802.11 protocols). In other instances, well-known instruction instances, protocols, structures, and techniques have not been shown in detail in order not to obfuscate the description.

A powerline communication (PLC) network typically includes a central coordinator that manages communications of other network devices in the PLC network. Some network devices may detect and establish a direct communication link with the central coordinator. Other network devices may not detect the central coordinator and may be referred to as “hidden network devices.” A hidden network device may identify and use an intermediate network device, which may be referred to as a “proxy network device,” for communicating with the central coordinator. The hidden network device may transmit messages to and receive messages from the central coordinator via the proxy network device. In accordance with PLC protocols (e.g., HomePlug GreenPHY protocols), the central coordinator may create and transmit a forwarding table to each network device in the PLC network to indicate how each network device should forward broadcast and multicast messages. Each network device simply forwards the received broadcast/multicast messages to other network devices in accordance with the forwarding table received from the central coordinator. However, such a mechanism may rely on the central coordinator to determine how each of the network devices should forward the broadcast/multicast messages. This may be a time-intensive and memory-intensive process depending on the resources available at the central coordinator and the number of network devices in the PLC network. Furthermore, indiscriminately forwarding the broadcast/multicast messages may result in the message being indefinitely retransmitted in the communication network (“broadcast message storms”) and retransmission of duplicate messages in the PLC network.

In some embodiments, a network device in the communication network can be configured to independently determine a forwarding table for forwarding broadcast and multicast messages in the communication network. The network device can determine the forwarding table without assistance from the central coordinator of the communication network. The network device can determine the forwarding table depending on whether the network device is associated with a proxy network device and/or whether the network device operates as a proxy network device for another network device. Furthermore, a network device may receive a message for broadcasting in the communication network. The network device may determine whether to forward the message via an upstream path or a downstream path of the communication network depending on whether the message includes a first indicator or a second indicator. Forwarding the message via the upstream path may involve re-transmitting the message from the network device to another network device in a network path leading towards the central coordinator or re-transmitting the message from the network device to the central coordinator. Forwarding the message via the downstream path may involve re-transmitting the message to another network device in a network path leading away from the central coordinator. If the message includes the first indicator, this can indicate that the central coordinator has previously forwarded the message. The network device may then re-transmit the message via the downstream path to all network devices (if any) for which the network device operates as a proxy network device. If the message includes the second indicator, this can indicate that the central coordinator has not received the message. The network device may then re-transmit the message via the upstream path—either directly to the central coordinator or to a proxy network device for subsequent forwarding to the central coordinator. When the central coordinator receives the message, the central coordinator can update the message to include the first indicator that indicates that the central coordinator has received the message. In addition to determining whether to forward the message via the upstream path or the downstream path, the network device may use information in the message to determine whether to forward the message or discard the message. Because the network device can be configured to determine its forwarding table depending on whether the network device has a proxy network device and/or operates as a proxy network device can preclude the central coordinator from providing forwarding tables to each network device in the communication network. This can also minimize the resources consumed by the central coordinator and messages transmitted in the communication network. Additionally, using the first and the second indicators included in a broadcast message to determine whether and how to forward the broadcast message in the communication network can minimize broadcast message storms and retransmission of duplicate messages in the communication network.

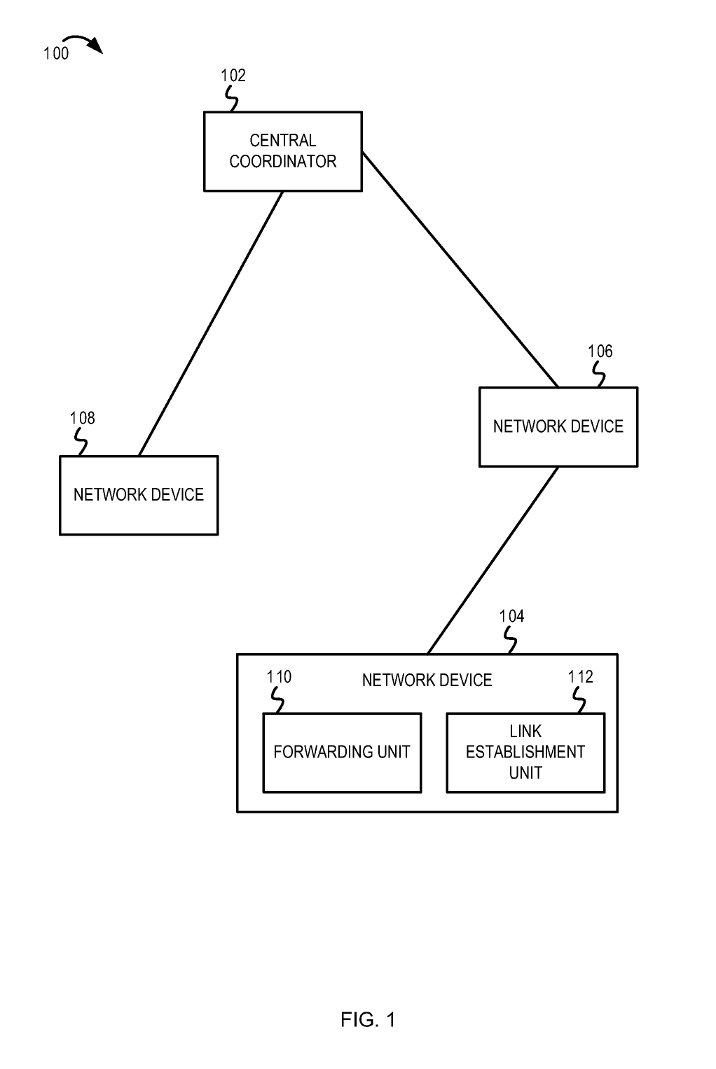

FIG. 1 is an example block diagram including a mechanism for forwarding messages in a communication network 100. The communication network 100 includes a central coordinator 102 and network devices 104, 106, and 108. The network device 104 includes a forwarding unit 110 and a link establishment unit 112. Although not depicted in FIG. 1, the central coordinator 102 and the network devices 106 and 108 may each include a forwarding unit and a link establishment unit.

In one example, the communication network 100 may be a HomePlug AV Logical Network (AVLN). The central coordinator 102 and network devices 104, 106, and 108 may each be PLC-capable network devices. Within the communication network 100, the central coordinator 102 and network devices 104, 106, and 108 may support any suitable network topology, such as a mesh topology, tree topology, star topology, bus topology, etc. In some implementations, the central coordinator 102 and the network devices 104, 106, and 108 may each be an electronic device in an outdoor PLC environment. For example, the outdoor PLC environment can be a smart power grid. In this example, the central coordinator 102 and the network devices 104, 106, and 108 may each be PLC devices or PLC-capable electronic devices configured to operate in the outdoor environment, such as power meters, electric vehicle charging stations, electric vehicles, power generators, electric power distribution devices, etc. In some implementations, the central coordinator 102 and the network devices 104, 106, and 108 may each be PLC-capable electronic devices in an indoor environment (e.g., a home network). In this implementation, the central coordinator 102 and the network devices 104, 106, and 108 may be PLC-capable electronic devices such as laptop computers, tablet computers, mobile phones, smart appliances, wearable devices, gaming consoles, access points, or other suitable electronic devices. In some implementations, the central coordinator 102 and the network devices 104, 106, and 108 may be PLC-capable electronic devices that can be located in the indoor PLC environment or in the outdoor PLC environment. In some embodiments, the central coordinator 102 and network devices 104, 106, and 108 can be configured to communicate using HomePlug AV communication protocols, HomePlug GreenPHY communication protocols, or other suitable powerline communication protocols. In some embodiments, in addition to PLC protocols, the central coordinator 102 and the network devices 104, 106, and 108 may implement other wired or wireless communication protocols (e.g., Bluetooth®, WiMAX, Ethernet, WLAN (e.g., IEEE 802.11 protocols), etc.). Furthermore, in some embodiments, the central coordinator 102 and the network devices 104, 106, and 108 may each include one or more radio transceivers, processors, analog front end (AFE) units, memory, and/or logic to implement the communication protocols and related functionality.

In some embodiments, the central coordinator 102 may be a network device that controls communications within the communication network 100. The network devices 104, 106, and 108 can associate with the central coordinator 102 to join the communication network 100. However, in some embodiments, communication between two network devices in the communication network 100 may not be reliable (or possible) due to longer distances, network congestion, or poor signal quality. For example, the link establishment unit 112 of the network device 104 may not receive a central beacon message from the central coordinator 102 and therefore may not detect the central coordinator 102. The network device 104 that is unable to establish a direct communication link with the central coordinator 102 may be referred to as a “hidden network device.” If the link establishment unit 112 is unable to detect the central coordinator 102, the hidden network device 104 may attempt to communicate with the central coordinator 102 via an intermediate “proxy” network device (e.g., the network device 106).

In some embodiments, a network device in the communication network 100 can be configured to generate its forwarding table for forwarding broadcast and multicast messages in the communication network 100. The forwarding table may be determined based on knowledge of hidden network devices serviced by the network device and/or a proxy network device (or central coordinator) that services the network device. For example, the network devices 106 and 108 may detect and establish a direct communication link with the central coordinator 102. The network device 104 may be unable to detect the central coordinator 102 and may be designated a hidden network device. The network device 104 may select the network device 106 as its proxy network device. The network device 104 may estimate the performance measurement of a communication link between the network device 104 and each additional network device that can be detected by the network device 104. The network device 104 may select the additional network device that is associated with a preferred performance measurement (e.g., highest signal-to-noise ratio) as the proxy network device. Alternatively, the network device 104 may use other suitable techniques to select its proxy network device. In the example of FIG. 1, the forwarding table of the network device 106 may indicate that the central coordinator 102 is directly connected in the upstream path (“upstream network device”) of the network device 106. The forwarding table may also indicate that the network device 106 operates as the proxy network device for the hidden network device 104. In other words, the forwarding table may indicate that the hidden network device 104 is directly connected in the downstream path (“downstream network device”) of the network device 106. As another example, the forwarding table of the hidden network device 104 may indicate that the proxy network device 106 is directly connected in the upstream path of the network device 104 and that there are no network devices connected in the downstream path of the network device 104. As another example, the forwarding table of the central coordinator 102 may indicate that the network devices 106 and 108 are directly connected in the downstream path of the central coordinator 102 and that there are no network devices connected in the upstream path of the central coordinator 102.

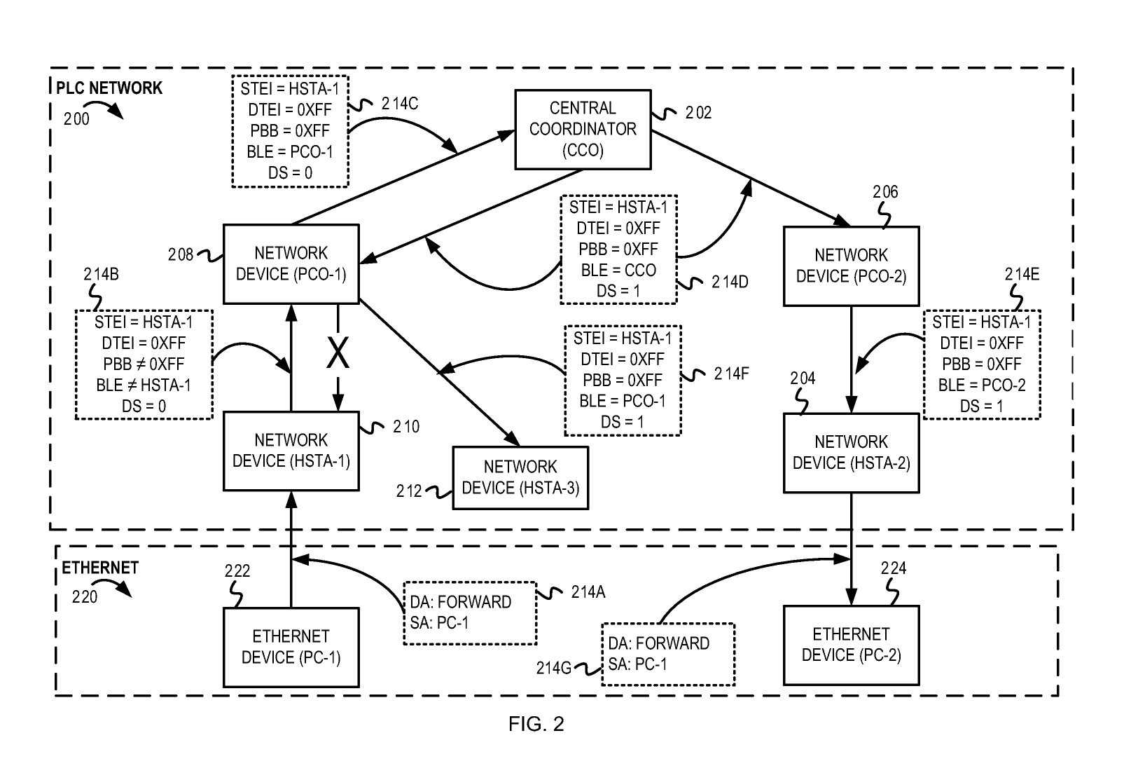

In addition to the forwarding table, a network device may analyze the frame control field of a message to determine whether/how to forward the message in the communication network 100. The message may be a broadcast message or a multicast message that will be forwarded to one or more network devices in the communication network. In some embodiments, the message may include a predetermined field that indicates whether the central coordinator 102 previously forwarded the message. For example, the predetermined field can indicate whether the central coordinator received the message from another network device of the same communication network, whether the central coordinator received the message from another network device of a different communication network, whether the central coordinator generated the message for transmitting in the communication network, etc. The predetermined field may include a first indicator or a second indicator depending on whether the central coordinator 102 previously forwarded the message. For example, if the message includes the first indicator, this can indicate that the central coordinator 102 has received (or generated) the message. However, if the message includes the second indicator, this can indicate that the central coordinator 102 has not received the message. A forwarding unit (not shown) of the central coordinator 102 may update the predetermined field when the central coordinator 102 receives the message. The forwarding unit may also update the predetermined field if the central coordinator 102 generates the message. A network device 104, 106, or 108 that receives a message for forwarding may determine whether to forward the message via an upstream path or a downstream path of the communication network 100 based, at least in part, on the indictor in the predetermined field. In one embodiment, the predetermined field may be referred to as a “downstream field” or “DS field” of the frame control field. If the downstream field includes the first indicator (e.g., DS=0), the forwarding unit 110 may determine that the central coordinator 102 has not previously received the message or did not originally generate the message. Accordingly, the forwarding unit 110 may re-transmit the message via the upstream path of the communication network 100. To transmit the message via the upstream path, the forwarding unit 110 may transmit the message either directly to the central coordinator 102 or to a proxy network device for subsequent forwarding to the central coordinator 102, as will be described with reference to FIG. 2. Alternatively, if the downstream field includes the second indicator (e.g., DS=1), the forwarding unit 110 may determine that the central coordinator 102 previously received the message or originally generated the message. Accordingly, the forwarding unit 110 may re-transmit the message via the downstream path of the communication network 100. To transmit the message via the downstream path, the forwarding unit 110 may transmit the message to all network devices (if any) for which the network device operates as a proxy network device, as will be described with reference to FIG. 2. Prior to transmitting the message to a hidden network device, the forwarding unit 110 may determine whether the source identifier included in the message matches a device identifier of the hidden network device. For example, the source identifier may be included in a source terminal equipment identifier field or STEI field of the message. The source identifier may refer to a device identifier associated with the network device that originally generated the message for transmitting in the communication network. If there is a match, the forwarding unit 110 may determine that the hidden network device generated the message and therefore, may not retransmit the message to the hidden network device. Instead, the forwarding unit 110 may forward the message to other hidden network devices (if any) associated with the network device. Alternatively, the network device may simply process the message without forwarding the message in the communication network.

Additionally, a network device in the communication network 100 can be configured to include information in the frame control field to indicate whether the message was previously forwarded in the communication network 100. For example, as will be further described in FIG. 2, a network device may transmit a predefined value in a first frame control field of the message to indicate that the message was previously forwarded in the communication network 100. The network device may also include its device identifier in a second frame control field of the message when the message was previously forwarded in the communication network 100. The device identifier may be a medium access control (MAC) address, a terminal equipment identifier, a network address, or another suitable identifier that uniquely identifies the network device. More generally, the second frame control field may include a device identifier (“forwarding device identifier”) associated with a network device that is currently forwarding the message. In one example, the first frame control field may be a physical layer (PHY) block body (PBB) field; while the second frame control field may be a bit load estimate (BLE) field. As will be further described below, the forwarding unit 110 may use the source identifier and/or the forwarding device identifier to determine whether to re-transmit the message in the communication network or whether to discard the message. If the downstream field includes the first indicator (e.g., DS=0), the forwarding unit 110 may compare the source identifier and/or the forwarding device identifier against a device identifier of each downstream network device that is directly connected with the network device to determine whether to re-transmit the message via the upstream path. If the downstream field includes the second indicator (e.g., DS=1), the forwarding unit 110 may compare the source identifier and/or the forwarding device identifier against a device identifier of an upstream network device that is directly connected with the network to determine whether to re-transmit the message via the downstream path. The forwarding unit 110 may re-transmit the message only if the identifier indicated the message matches a device identifier of the upstream network device or downstream network device. If there is no match, the forwarding unit 110 may discard the message.

In some embodiments, the forwarding unit 110 of a receiving network device may evaluate the information in the first frame control field (e.g., PBB field), the second frame control field (e.g., BLE field), the downstream field (e.g., DS field), and/or the source identifier field (e.g., STEI field) to determine whether and how to forward the message. For example, if: A) the first frame control field does not include a predefined value (e.g., PBB≠0xFF), B) the source identifier field includes a device identifier of a downstream network device that is directly connected with the receiving network device, and C) the central coordinator has not received or generated the message (e.g., DS=0), then the forwarding unit 110 may determine that the downstream network device originally generated the message. Accordingly, the forwarding unit 110 may forward the message via the upstream path to the central coordinator 102. Alternatively, the forwarding unit 110 may forward the message via the upstream path to an upper-level proxy network device for subsequent forwarding to the central coordinator 102. As another example, the forwarding unit 110 of a receiving network device may determine that the message was generated by the central coordinator and may re-transmit the message via the downstream path if: A) the first frame control field does not include the predefined value (e.g., PBB≠0xFF), B) the source identifier field includes a device identifier of the central coordinator, and C) the central coordinator has received or generated the message (e.g., DS=1). Other examples for determining whether to forward the message in the communication network and whether to forward the message via the upstream path or the downstream path are further described with reference to FIGS. 2-6.

Although examples refer to using the BLE field, the DS field, the PBB field, and/or the STEI field to determine whether and how to forward a message (e.g., a broadcast message or a multicast message) in the communication network, embodiments are not so limited. In other embodiments, the network devices may use other suitable fields, any suitable number of bits, and/or any other type of indicators to determine whether and how to forward the message.

FIG. 2 is an example conceptual diagram illustrating a mechanism for forwarding messages in a communication network. FIG. 2 depicts a PLC network 200 and an Ethernet 220. In some embodiments, FIG. 2 may represent a hybrid communication network that includes an interconnection between the PLC network 200 and the Ethernet 220. The PLC network 200 includes a central coordinator (CCo) 202 and network devices 204, 206, 208, 210, and 212. The Ethernet 220 includes Ethernet devices 222 and 224. In the PLC network 200, the network devices 204, 210, and 212 are hidden network devices that are unable to establish a direct communication link with the central coordinator 202. The network device 204 uses the network device 206 as a proxy network device for communicating with the central coordinator 202. The network devices 210 and 212 use the network device 208 as a proxy network device for communicating with the central coordinator 202. In some embodiments, as depicted in FIG. 2, the proxy network devices 206 and 208 may each detect and establish a direct communication link with the central coordinator 202. However, in other embodiments, the proxy network device 206 and/or 208 may identify another upper-level proxy network device for communicating with the central coordinator 202. In the example of FIG. 2, the Ethernet device 222 is connected with the network device 210; while the Ethernet device 224 is connected with the network device 204.

FIG. 2 depicts example interconnections between network devices and example messages exchanged between the network devices. In other embodiments, the PLC network may include any suitable number of network devices that are interconnected amongst each other to form any suitable type of communication network (e.g., a mesh network, etc.). Irrespective of the interconnections between the network devices, the communication network may be represented as a network tree, where each network device is either directly connected to the central coordinator or to an upper-level proxy network device. Additionally, a network device may operate as a proxy network device for one or more hidden network devices. A network device that does not service any hidden network devices may be referred to as a “leaf node” of the network tree. In some embodiments, the PLC network may not be interconnected with other heterogeneous communication networks. In some embodiments, the PLC network may not be connected with the Ethernet 220. Instead, the PLC network 200 may be connected with other suitable communication networks (e.g., WLAN, MoCA, etc.).

The Ethernet device 222 generates a message 214A for transmitting in the Ethernet 220 and the PLC network 200. The source address (SA) field in the message 214A includes a device identifier of the Ethernet device 222 (e.g., SA=PC-1). The device identifier may be a MAC address, TEI, a network address, or another suitable device identifier that uniquely identifies the network device. The destination address (DA) field in the message 214A includes a predefined forwarding identifier that indicates that the message 214A should be forwarded in the networks 200 and 220 (e.g., DA=FORWARD). The Ethernet device 222 transmits the message 214A to the network device 210 of the PLC network 200 and to other network devices (not shown) that are directly connected with the Ethernet device 222.

In the PLC network 200, the network device 210 receives the message 214A from the Ethernet device 222 for forwarding in the PLC network 200. The network device 210 updates information in the frame control field of the message 214A to generate message 214B for subsequently forwarding in the PLC network 200. The network device 210 receives the message 214A from an external communication network and is the initial network device in the PLC network 200 that receives the message 214A. Therefore, the network device 210 includes its device identifier in a source identifier field of the frame control field to generate the message 214B. In the example of FIG. 2, the network device 210 includes its device identifier in an STEI field (e.g., STEI=HSTA-1) to generate the message 214B. Furthermore, the network device 210 includes a predefined forwarding identifier in the destination identifier field of the message 214B to indicate that the message 214B should be forwarded in the PLC network 200. In the example of FIG. 2, the network device 210 includes the predefined forwarding identifier in the destination terminal equipment identifier (DTEI) field (e.g., DTEI=0xFF). Additionally, the message 214A is received at the network device 210 from the Ethernet 220 and was not previously forwarded in the PLC network 200. Therefore, the network device 210 includes a predefined value in a first frame control field of the message 214B (e.g., PBB≠0xFF) to indicate that the message was not previously forwarded in the PLC network 200. The network device 210 also does not include its device identifier in a second frame control field of the message 214B (e.g., BLE≠HSTA-1) to indicate that the message was not previously forwarded in the PLC network 200. Additionally, because the network device 210 received the message from the Ethernet 220, the network device 210 determines that the central coordinator has not previously forwarded the message 214A. The message 214B may include a default indicator in the downstream field (e.g., DS=0) to indicate that the central coordinator 202 has not received the message from another network device of the PLC network, has not received the message from another network device of a different communication network, or has not generated the message 214B. The network device 210 determines to forward the message 214B to the central coordinator 202 via the upstream path of the PLC network 200. The network device 210 accesses its forwarding table and determines that the network device 208 operates as a proxy network device for the network device 210. Specifically, the network device 210 determines that the network device 208 is directly connected with the network device 210 in the upstream path. The network device 210 forwards the message 214B to the network device 208 connected via the upstream path.

The network device 208 receives the message 214B from the network device 210. The network device 208 determines that the source identifier in the received message 214B matches the device identifier of a downstream network device 210 directly connected with the network device 208 (e.g., STEI=HSTA-1). Therefore, the network device 210 determines to forward the message 214B in the PLC network 200. The network device 206 updates information in the frame control field of the message 214B to generate message 214C for subsequent forwarding in the PLC network 200. Because the source identifier in the received message 214B matches the device identifier of a downstream network device 210 directly connected with the network device 208, the network device 208 determines that the message 214B was previously transmitted in the PLC network 200. To form the message 214C, the network device 208 includes a predefined value in the first frame control field (e.g., PBB=0xFF) to indicate that the message 214C was previously forwarded in the PLC network 200. The network device 208 also includes its device identifier in the second frame control field of the message 214B (e.g., BLE=PCo-1) to indicate that the network device 208 is currently forwarding the message 214C. The network device 208 may not change the source identifier (e.g., STEI) and destination identifier (e.g., DTEI) in the message 214C. Thus, as depicted in FIG. 2, the STEI field of the message 214C includes the device identifier of the network device 210 and the DTEI field includes the predefined forwarding identifier. The network device 208 also determines that the central coordinator 202 has not received or generated the message 214B based on the indicator in the downstream field (e.g., DS=0). The network device 206 may propagate this indicator in the downstream field from the message 214B into the message 214C. Based on the indicator in the downstream field (e.g., DS=0), the network device 208 may determine to forward the message 214C via the upstream path. The network device 208 can access its forwarding table and determine that the network device 208 is directly connected with the central coordinator in the upstream path. In other words, the network device 208 may determine that the network device 208 is connected with the central coordinator via one communication hop or one communication link. Therefore, the network device 208 forwards the message 214C to the central coordinator 202 via the upstream path.

The central coordinator 202 receives the message 214C from the network device 208. The central coordinator 202 determines that the second frame control field of the received message 214C matches the device identifier of a downstream network device 208 directly connected with the central coordinator 202 (e.g., BLE=PCo-1). Therefore, the central coordinator 202 determines to forward the message 214C in the PLC network 200. The central coordinator 202 updates information in the frame control field of the message 214C to generate the message 214D for subsequent forwarding in the PLC network 200. The central coordinator 202 updates the downstream field to indicate that the central coordinator 202 has received the message. In the example of FIG. 2, the central coordinator 202 sets DS=1 in the message 214D. Additionally, because the second frame control field of the received message 214B matches the device identifier of the downstream network device 208 directly connected with the central coordinator 202, the central coordinator 202 determines that the message was previously transmitted in the PLC network 200. Accordingly, the central coordinator 202 may ensure that the message 214D includes a predefined value in the first frame control field (e.g., PBB=0xFF) to indicate that the message 214D was previously forwarded in the PLC network 200. The central coordinator 202 may also include its device identifier in the second frame control field of the message 214D (e.g., BLE=CCo) to indicate that the message was previously forwarded in the PLC network 200 and to indicate that the central coordinator 202 is currently forwarding the message 214D. The central coordinator 202 may not change the source identifier and destination identifier in the message 214D. Thus, as depicted in FIG. 2, the STEI field of the message 214D includes the device identifier of the network device 210 and the DTEI field includes the predefined forwarding identifier. After forming the message 214D, the central coordinator 202 may access its forwarding table and identify downstream network devices that are directly connected with the central coordinator 202. In the example of FIG. 2, the central coordinator 202 determines that the network devices 206 and 208 are directly connected with the central coordinator 202 in the downstream path. Therefore, the central coordinator 202 forwards the message 214D to the network devices 206 and 208.

The network device 206 receives the message 214D from the central coordinator 202. The network device 206 determines that the second frame control field of the received message 214D matches the device identifier of an upstream network device 202 directly connected with the network device 206 (e.g., BLE=CCo). Therefore, the network device 206 determines to forward the message 214D in the PLC network 200. The network device 206 updates information in the frame control field of the message 214D to generate message 214E for subsequent forwarding in the PLC network 200. Because the second frame control field of the received message 214D matches the device identifier of an upstream network device 202, the network device 206 determines that the message 214D was previously transmitted in the PLC network 200. Accordingly, the network device 206 may ensure that the message 214E includes a predefined value in the first frame control field (e.g., PBB=0xFF) to indicate that the message was previously forwarded in the PLC network 200. The network device 206 also includes its device identifier in the second frame control field of the message 214E (e.g., BLE=PCo-2) to indicate that the network device 206 is currently forwarding the message 214E. The network device 206 may not change the source identifier and destination identifier in the message 214E. Thus, as depicted in FIG. 2, the STEI field of the message 214E includes the device identifier of the network device 210 and the DTEI field includes the predefined forwarding identifier. The network device 206 also determines that the central coordinator 202 has received (or generated) the message 214D based on the indicator in the downstream field (e.g., DS=1). The network device 206 may propagate this indicator in the downstream field from the message 214D into the message 214E. Based on the indicator in the downstream field (e.g., DS=1), the network device 206 determines to forward the message 214E via the downstream path of the PLC network 200 and not to forward the message 214E via the upstream path of the PLC network 200. The network device 206 may access its forwarding table and determine that the network device 206 is directly connected with the network device 204 via the downstream path. Therefore, the network device 206 forwards the message 214E to the network device 204 via the downstream path.

The network device 204 receives the message 214E from the network device 206. The network device 204 determines that the second frame control field of the received message 214E matches the device identifier of an upstream network device 206 directly connected with the network device 204 (e.g., BLE=PCo-2). Therefore, the network device 204 determines to forward the message 214E in the PLC network 200. The network device 206 may also read the downstream field of the received message 214E and determine that the central coordinator 202 has previously forwarded the message 214E (e.g., DS=1). This indicator in the downstream field may indicate that the central coordinator 202 has received the message from another network device of the PLC network, has received the message from another network device of a different communication network, or has generated the message 214E. Therefore, the network device 204 determines to forward the message 214E via the downstream path of the PLC network 200. Based on the forwarding table, the network device 204 may determine that the network device 204 is not directly connected with another downstream network device in the PLC network 200. However, the network device 204 may determine that the Ethernet device 224 is connected with the network device 204. In some embodiments, the network device 204 may update one or more fields of the received message 214E to generate Ethernet message 214G for forwarding to the Ethernet device 224 (e.g., PC-2). In other embodiments, the network device 204 may include the payload and other suitable information (e.g., source identifier, destination identifier, etc.) in a new Ethernet message 214G. The message 214G includes the device identifier of the Ethernet device 222 in the source address field (e.g., SA=PC-1) and the predefined forwarding identifier in the destination address field (e.g., DA=FORWARD). The network device 204 forwards the message 214G from the PLC network 200 to the Ethernet device 224 of the Ethernet 220. The Ethernet device 224 may continue to forward the message 214G to other network devices in the Ethernet 220 and/or to other suitable communication networks. Although not shown in FIG. 2, it is noted that the messages 214B, 214C, 214D, 214E, and 214F may also include the source address field (e.g., SA=PC-1) and the destination address field (e.g., DA=FORWARD). As described above, in one implementation, the STEI, DTEI, PBB, BLE and DS may be part of the frame control field of the message. The DA may be part of the MAC destination address field of the message, and the SA may be part of the MAC source address field of the message.

The network device 208 receives the message 214D from the central coordinator 202. The network device 208 determines that the second frame control field of the received message 214D matches the device identifier of an upstream network device 202 directly connected with the network device 206 (e.g., BLE=CCo). Therefore, the network device 208 determines to forward the message 214D in the PLC network 200. The network device 208 may read the downstream field of the received message 214D (e.g., DS=1) and determine that the central coordinator 202 received or generated the message 214D. Accordingly, the network device 208 determines to forward the message 214D via the downstream path of the PLC network 200 and not to forward the message 214D via the upstream path of the PLC network 200. The network device 208 may access its forwarding table and identify the downstream network devices that are directly connected with the network device 208. With reference to the example of FIG. 2, the network device 208 determines that it operates as the proxy network device for hidden network devices 210 and 212. The network device 208 may then determine whether to forward the message 214D to the downstream network devices 210 and 212. For this, the network device 208 may compare the device identifier of the downstream network devices 210 and 212 against the source identifier included in the message 214D. For example, the network device 208 may compare the device identifier of the network devices 210 and 212 against the source identifier in the STEI field. Based on this comparison, the network device 208 determines that the device identifier of the network device 210 matches the source identifier included in the message 214D (e.g., STEI=HSTA-1). The network device 208 determines that the network device 210 generated the message 214D or received the message from another communication network. Therefore, the network device 208 determines not to forward the message 214D to the downstream network device 210. Instead, the network device 208 determines to only forward the message 214D to the downstream network device 212. The network device 208 updates information in the frame control field of the message 214D to generate message 214F for subsequent forwarding in the PLC network 200. Because the second frame control field of the received message 214D matches the device identifier of an upstream network device 202, the network device 208 determines that the message 214D was previously forwarded in the PLC network 200. Accordingly, the network device 208 may ensure that the first frame control field of the message 214F includes the predefined value (e.g., PBB=0xFF) to indicate that the message was previously forwarded in the PLC network 200. The network device 208 also includes its device identifier in the second frame control field of the message 214F (e.g., BLE=PCo-1) to indicate that the network device 208 is currently forwarding the message 214F. Additionally, the message 214F may indicate that the central coordinator 202 has previously forwarded the message (e.g., DS=1). The network device 208 may then transmit the message 214F to the network device 212. However, as described above, the network device 208 may not transmit the message 214F to the network device 210 (represented by an “X” indicator).

The network device 212 receives the message 214F from the network device 208. The network device 212 determines that the second frame control field of the received message 214F matches the device identifier of an upstream network device 208 directly connected with the network device 212 (e.g., BLE=PCo-1). The network device 212 also determines that the central coordinator 202 received or generated the message 214F based on the indicator in the downstream field (e.g., DS=1) of the received message 214F. Therefore, the network device 212 may determine to forward the message 214F via the downstream path. However, after accessing the forwarding table, the network device 212 may determine that the network device 212 is not directly connected with another downstream network device of the PLC network 200. After processing the message 214F, the network device 212 may discard the message 214F and determine not to forward the message in the PLC network 200.

Although FIG. 2 depicts the Ethernet device 222 generating the message for forwarding in the networks 200 and 220, in other embodiments, any suitable network device may generate a message that will be forwarded in the PLC network 200. For example, the network device 206 may generate the message for transmitting in the PLC network 200. The network device 206 may transmit the message via the upstream path to the central coordinator 202. The central coordinator 202 may then forward (or repeat) the message via the downstream path to the network devices 206 and 208. The network device 206 may further forward the message via the downstream path to network devices 210 and 212; while the network device 208 may further forward the message via the downstream path to network device 204. More generally, the message (e.g., the broadcast message or multicast message) is first forwarded to the central coordinator via the upstream path of the communication network. After the central coordinator receives the message, the message is forwarded to the leaf network devices via the downstream path of the communication network. At each stage, the network device may determine whether to forward the message via the upstream path or the downstream path based on the indicator in the downstream field of the received message. Furthermore, the network device may determine whether to forward the message or discard the message depending on whether the source identifier (or forwarding device identifier) in the received message matches the device identifier of another network device that is directly connected with the network device.

In some embodiments, as depicted with reference to FIG. 2, a proxy network device 206 may be connected with the central coordinator 202 via one communication hop or one communication link. In other embodiments, however, the proxy network device 206 may not be directly connected with the central coordinator 202. Instead, the proxy network device may also be a hidden network device and may be unable to detect the central coordinator 202. In this embodiment, the proxy network device 206 (“lower-level proxy network device”) may have an upper-level proxy network device that enables communication between the lower-level proxy network device and the central coordinator 202. The forwarding table of the lower-level proxy network device can indicate that the upper-level proxy network device is directly connected with the lower-level proxy network device via the upstream path. The forwarding table can indicate that the hidden network device(s) are directly connected with the lower-level proxy network device via the downstream path.

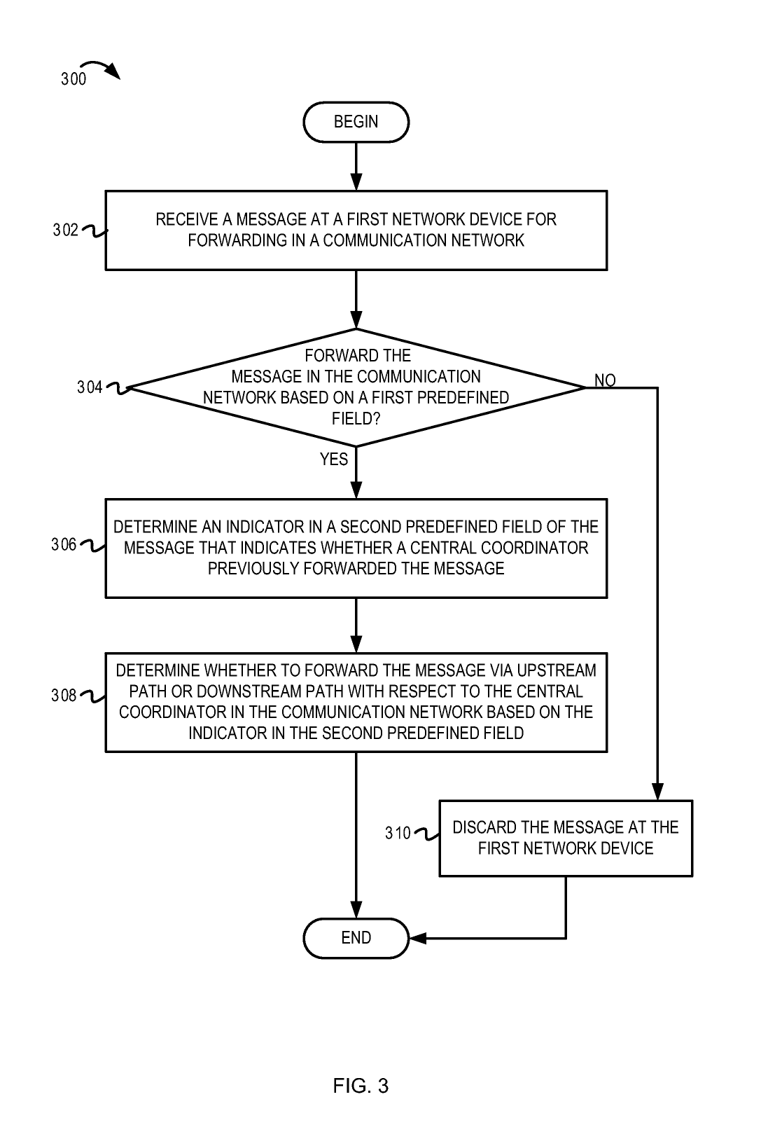

FIG. 3 is a flow diagram (“flow”) 300 illustrating example operations of a network device for forwarding messages in a communication network. The flow 300 begins at block 302.

At block 302, a first network device receives a message for forwarding in a communication network. The message may be a broadcast message or a multicast message. In some embodiments, the first network device may receive the message from a second network device of the same communication network. With reference to the example of FIG. 2, the network device 208 may receive a message generated by the network device 210 for forwarding in the PLC network 200. In another embodiment, the first network device may receive a message from a second network device of a different communication network. With reference to the example of FIG. 2, the network device 208 may receive the message 214A from the Ethernet device 222 of the Ethernet 200 for forwarding in the PLC network 200. In yet another embodiment, the first network device may generate a message for transmitting in the communication network. For example, the network device 208 may generate a message for broadcasting in the PLC network 200. The flow continues at block 304.

At block 304, the first network device determines whether to forward the message in the communication network based, at least in part, on a first predefined field in the message. In one embodiment, the forwarding unit can compare a device identifier in the received message with a device identifier of each network device that is directly connected with the first network device. The device identifier received in the message may include the source identifier or a device identifier (“forwarding device identifier”) of another network device that transmitted the message to the first network device. The forwarding table associated with the first network device may include an upstream data entry that includes a device identifier of the upstream network device that is directly connected with the first network device via the upstream path. The upstream network device may be the central coordinator or an upper-level proxy network device. The forwarding table associated with the first network device may include a downstream data entry for each downstream network device that is directly connected with the first network device via the downstream path. The downstream network device may be a hidden network device for which the first network device operates as a proxy network device. In one example, the forwarding unit can compare the device identifier in the received message (e.g., source identifier or forwarding device identifier) against the device identifier of each downstream network device that is directly connected with the first network device. As another example, the forwarding unit can compare the device identifier in the received message (e.g., source identifier or forwarding device identifier) against the device identifier of the upstream network device that is directly connected with the first network device. In each example, if the device identifier in the received message matches the device identifier of another network device that is directly connected with the first network device, the forwarding unit may determine to forward the message in the communication network. However, in each example, if the device identifier in the received message does not match the device identifier of another network device that is directly connected with the first network device, the forwarding unit may not forward the message in the communication network. If it is determined to forward the message, the flow continues at block 306. Otherwise, the flow continues at block 310.

At block 306, the first network device determines an indicator in a second predefined field of the message, wherein the second predefined field indicates whether that a central coordinator has previously forwarded the message. With reference to the example of FIG. 2, each message may include a downstream field (or DS field) that indicates whether the central coordinator 202 previously forwarded the message. For example, the downstream field can indicate whether the central coordinator 202 received the message from another network device of the same communication network, whether the central coordinator 202 received the message from another network device of a different communication network, whether the central coordinator 202 generated the message for transmitting in the communication network, etc. In FIG. 2, the message 214B received by the network device 208 includes a first indicator in the downstream field (e.g., DS=0). The first indicator can indicate that the central coordinator 202 has not received or generated the message 214B. As another example, the message 214D received by the network device 206 includes a second indicator in the downstream field (e.g., DS=1). The second indicator can indicate that the central coordinator 202 has received or generated the message 214D. The network device may determine how to forward the message in the communication network based, at least in part, on the indicator in the second predefined field. The flow continues at block 308.

At block 308, the first network device determines whether to forward the message via an upstream path or the downstream path with respect to the central coordinator in the communication network based, at least in part, on the indicator in the second predefined field. As described above, the second predefined field can indicate whether the central coordinator has previously forwarded the message. For example, the forwarding unit 110 determines how to forward the message based, at least in part, on the indicator in the second predefined field (e.g., the downstream field). In one example, if the downstream field includes the first indicator (e.g., DS=0), the forwarding unit 110 may determine that the central coordinator 202 has not received or generated the message. The forwarding unit 110 may determine to transmit the message via the upstream path of the communication network. However, if the downstream field includes the second indicator (e.g., DS=1), the forwarding unit 110 may determine that the central coordinator 202 has previously received or generated the message. In this example, the forwarding unit 110 may determine to transmit the message via the downstream path of the communication network.

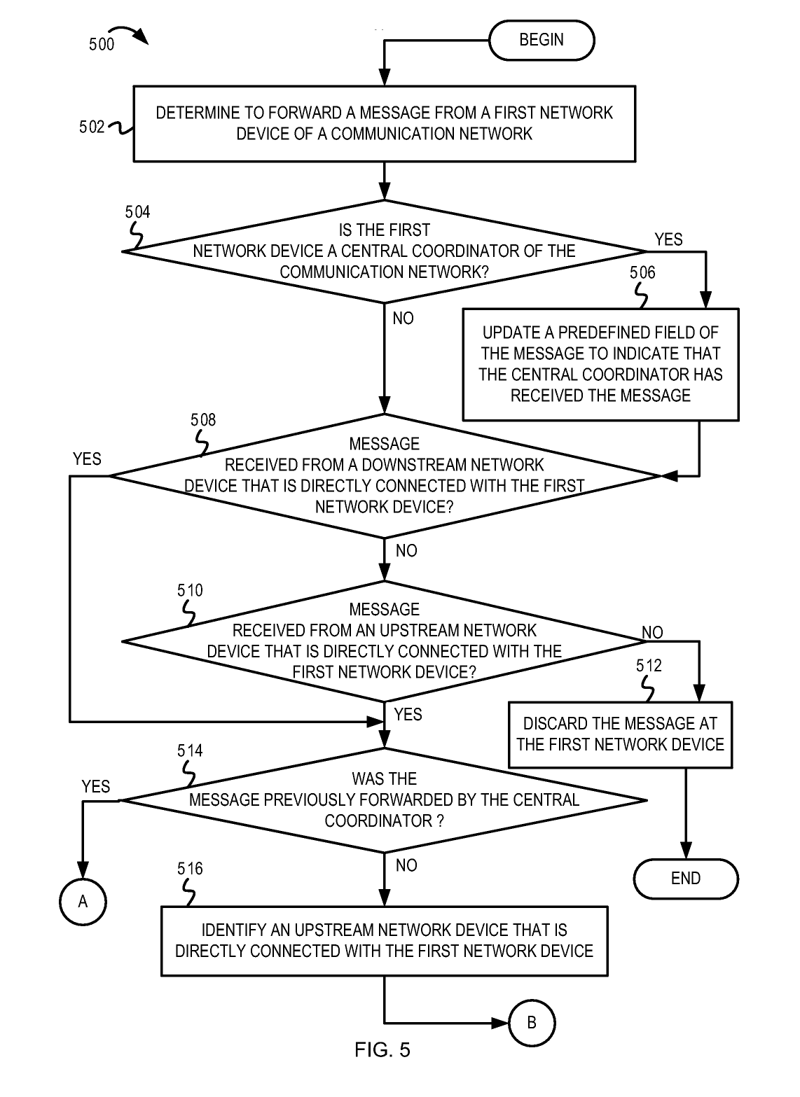

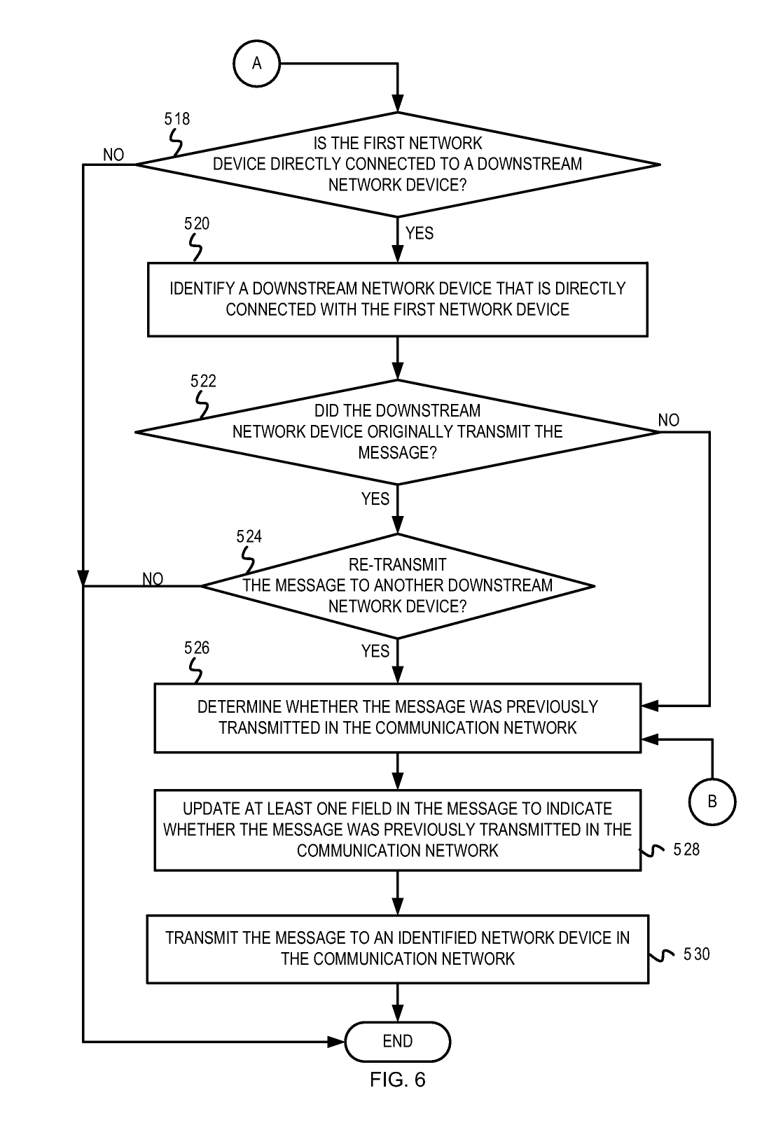

As will be further described in FIGS. 5 and 6, if the downstream field includes the first indicator, the forwarding unit 110 may identify an upper-level proxy network device or the central coordinator that is directly connected with the first network device in the upstream path. The forwarding unit 110 may update information in the frame control field of the received message, as described above with reference to FIG. 2. The forwarding unit 110 may then transmit the resultant message to the upper-level proxy network device or the central coordinator. However, if the downstream field includes the second indicator, the forwarding unit 110 may identify additional network devices that are directly connected with the network device in the downstream path, as will be further described in FIGS. 5 and 6. Specifically, the forwarding unit 110 may determine whether the first network device operates as a proxy network device for a hidden network device. If so, the forwarding unit 110 may determine whether to forward the message to the hidden network device based, at least in part, on a source identifier in the received message and a device identifier associated with the hidden network device. If it is determined to forward the message to the hidden network device, the forwarding unit 110 may update information in the frame control field of the received message, as described above with reference to FIG. 2. The forwarding unit 110 may then transmit the resultant message to the hidden network device. From block 308, the flow ends.

At block 310, if the first network device determines not to forward the message in the communication network, the message is discarded at the first network device. As described above, the first network device may compare the device identifier in the received message (e.g., source identifier or forwarding device identifier) against the device identifier of each network device that is directly connected with the first network device. If there is no match, the first network device may determine not to process or forward the message in the communication network. Accordingly, the first network device may discard the message. From block 310, the flow ends.

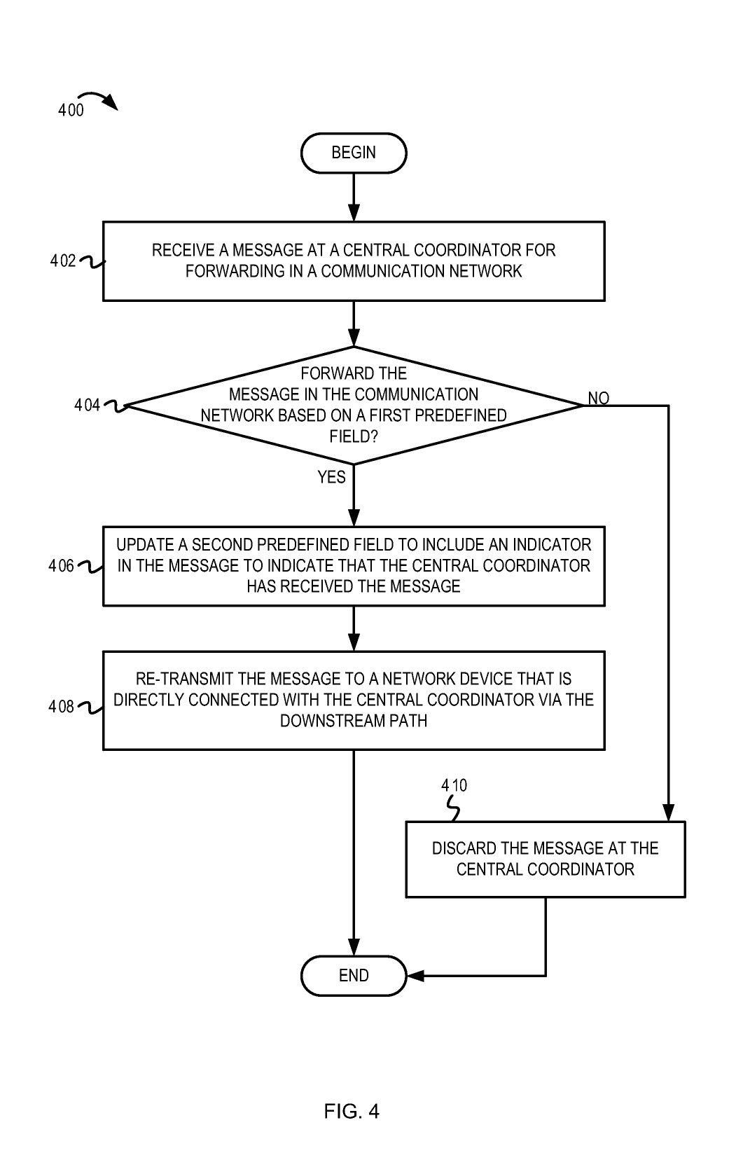

FIG. 4 is a flow diagram 400 illustrating example operations of a central coordinator for forwarding messages in a communication network. The flow 400 begins at block 402.

At block 402, a central coordinator receives a message for forwarding in a communication network. The message may be a broadcast message or a multicast message. In some embodiments, the central coordinator may receive a message from another network device of the same communication network. With reference to the example of FIG. 2, the central coordinator 202 may receive a message generated by or forwarded by the network device 208 of the PLC network 200. In another embodiment, the central coordinator 202 may generate a message for transmitting in the PLC network 200. In another embodiment, the central coordinator of a first communication network may receive a message from a network device of a second communication network for forwarding in the first communication network. For example, the central coordinator 202 of the PLC network 200 may receive a message from an Ethernet device of the Ethernet 220 for forwarding in the PLC network 200. The flow continues at block 404.

At block 404, the central coordinator determines whether to forward the message in the communication network based on a first predefined field in the message. To minimize the probability of receiving and forwarding duplicate messages in the communication network, the central coordinator (e.g., a forwarding unit) may determine whether to forward the message in the communication network. The central coordinator may compare a device identifier from the received message against the device identifier of each downstream network device that is directly connected with the central coordinator. For example, the central coordinator can compare the source identifier in the received message against the device identifier of each downstream network device that is directly connected with the central coordinator. As another example, the central coordinator can compare a forwarding device identifier in the received message against the device identifier of each downstream network device that is directly connected with the central coordinator. If there is a match, the central coordinator determines to forward the message in the communication network. Otherwise, the central coordinator determines that it inadvertently received the message and that the central coordinator was not designated to receive the message. Referring to the example of FIG. 2, the network device 210 may transmit the message 214B to the network device 208. The central coordinator 202 may receive the message 214B. The central coordinator 202 may determine that the source identifier in the message 214B does not match the device identifier of the downstream network devices 206 and 208 that are directly connected with the central coordinator. Accordingly, the central coordinator (e.g., a forwarding unit) may determine that the central coordinator was not intended to receive the message 214B. As another example, the central coordinator 202 may receive the message 214C from the network device 208. The central coordinator 202 may determine that the forwarding device identifier (e.g., in the BLE field) in the message 214C matches the device identifier of the downstream network device 208 that is directly connected with the central coordinator. Accordingly, the central coordinator (e.g., a forwarding unit) may determine to forward the message 214C in the communication network. If it is determined to forward the message in the communication network, the flow continues at block 406. Otherwise, the flow continues at block 410.

At block 406, the central coordinator updates a second predefined field to include an indicator in the message to indicate that the central coordinator has received the message. Each message may include a downstream field that indicates whether the central coordinator received or generated the message. The central coordinator 202 may update the downstream field when the central coordinator 202 receives or generates the message. Referring to the example of FIG. 2, the message 214C transmitted from the network device 208 to the central coordinator 202 includes a first indicator in the downstream field (e.g., DS=0). The first indicator can indicate that the central coordinator 202 has not received the message 214C. After receiving the message, the central coordinator 202 updates the downstream field to include a second indicator and to generate resultant message 214D. The second indicator (e.g., DS=1) can indicate that the central coordinator 202 has received the message 214D. The central coordinator 202 may then forward the message 214D including the second indicator to other network devices 206 and 208 in the PLC network 200. As another example, the central coordinator 202 may generate a message for transmitting in the PLC network 200. In this example, the central coordinator 202 may include the second indicator in the downstream field of the message prior to transmitting the message to the network devices 206 and 208. The flow continues at block 408.

At block 408, the central coordinator re-transmits the message to a network device that is directly connected with the central coordinator via the downstream path. After including the second indicator in the message to indicate that the central coordinator has received the message, the central coordinator can identify at least one downstream network device that is directly connected with the central coordinator. The central coordinator may then transmit the message including the second indicator to the identified network devices. In the example of FIG. 2, the central coordinator 202 determines that the network devices 206 and 208 are connected with the central coordinator in the downstream path via one communication hop or one communication link After updating the downstream field to include the second indicator (e.g., DS=1), the central coordinator 202 transmits the resultant message 214D to the network devices 206 and 208. In some embodiments, the central coordinator may forward a received message in the communication network. In this embodiment, as similarly described above in FIG. 2, the central coordinator 202 may also update the first frame control field to include a predefined value (e.g., PBB=0xFF) that indicates that the message was previously forwarded in the communication network. The central coordinator may also include its device identifier in a second frame control field (e.g., BLE=CCo). In other embodiments, the central coordinator may generate a message for forwarding in the communication network. In this embodiment, the central coordinator 202 may not include the predefined value in the first frame control field (e.g., PBB≠0xFF) to indicate that the message was not previously forwarded in the communication network. The central coordinator may not include its device identifier in the second frame control field (e.g., BLE≠CCo) to indicate that the message was not previously forwarded in the communication network. The central coordinator may include its device identifier in the source identifier field (e.g., STEI=CCo) to indicate that the central coordinator generated the message. From block 408, the flow ends.

At block 410, if the central coordinator determines not to forward the message in the communication network, the message is discarded at the central coordinator. As described above, the central coordinator may compare the device identifier in the received message (e.g., source identifier or forwarding device identifier) against the device identifier of each downstream network device that is directly connected with the central coordinator. If there is no match, the central coordinator may determine not to process or forward the message in the communication network. Accordingly, the central coordinator may discard the message. From block 410, the flow ends.

FIG. 5 and FIG. 6 depict a flow diagram 500 illustrating example operations for forwarding messages in a communication network. The flow 500 begins at block 502 in FIG. 5.

At block 502, a first network device determines to forward a message in a communication network. The message may be a broadcast message or a multicast message. In some embodiments, the first network device may generate the message for transmitting in the communication network. In another embodiment, the first network device may receive a message from a second network device of the same communication network. With reference to the example of FIG. 2, the network device 206 may receive a message generated by the network device 204 for forwarding in the PLC network 200. In another embodiment, the first network device may receive a message from a second network device of a different communication network. With reference to the example of FIG. 2, the network device 210 may receive a message from the Ethernet device 222 for forwarding in the PLC network 200. In some embodiments, the first network device may be a central coordinator of the communication network; while in other embodiments, the first network device may be another suitable device of the communication network. The flow continues at block 504.

At block 504, it is determined whether the first network device is the central coordinator of the communication network. If the first network device that received (or generated) the message for forwarding is the central coordinator, the flow continues at block 506. Otherwise, the flow continues at block 508.

At block 506, the central coordinator updates a predefined field of the message to indicate that the central coordinator has received the message. As described above with reference to FIGS. 2 and 4, each message may include a downstream field that indicates whether the central coordinator previously received or originally generated the message. In response to receiving the message 214C, a forwarding unit of the central coordinator 202 may update the downstream field to include a first indicator (e.g., DS =1) to indicate that the central coordinator received the message. Alternatively, if the central coordinator generates a message for transmitting in the communication network, the central coordinator may include the first indicator in the downstream field as part of the generated message. Additionally, the central coordinator may update other frame control fields of the received message 214C to generate a resultant message 214D, as described above with reference to FIG. 2. The flow continues at block 508.

At block 508, it is determined whether the message was received from another network device (“downstream network device”) that is directly connected to the first network device via the downstream path. For example, the forwarding unit 110 may determine whether to forward the message or whether to discard the message. The forwarding unit 110 may forward the message, if the message was received from a downstream network device that is directly connected with the first network device. The forwarding unit 110 may use various techniques to determine whether the message was received from the downstream network device that is directly connected with the first network device. For example, the forwarding unit 110 may compare the source identifier in the received message against the device identifier of each downstream network device that is directly connected with the first network device. As another example, the forwarding unit 110 may compare a forwarding device identifier in the received message (e.g., the BLE field) against the device identifier of each downstream network device. If the source identifier or the forwarding device identifier does not match the device identifier of any downstream network device that is directly connected with the first network device, it is determined that the message was not received from the downstream network device and the flow continues at block 510. Otherwise, if the message was received from the downstream network device, the flow continues at block 514.

At block 510, it is determined whether the message was received from another network device (“upstream network device”) that is directly connected with the first network device via the upstream path. For example, the forwarding unit 110 may forward the message in the communication network, if the message was received from an upstream network device that is directly connected with the first network device. As described above, the forwarding unit 110 may compare the source identifier or the forwarding device identifier in the received message against the device identifier of the upstream network device. If the source identifier or the forwarding device identifier does not match the device identifier of the upstream network device that is directly connected with the first network device, it is determined that the message was not received from the upstream network device. In this scenario, the forwarding unit 110 may determine that the first network device was not intended to receive the message and the flow continues at block 512. Otherwise, if there is a match, the flow continues at block 514.

At block 512, the message is discarded at the first network device. If the source identifier or the forwarding device identifier does not match the device identifier of any of the downstream network devices that are directly connected with the first network device, it is determined that the message was not intended for the network device. Likewise, if the source identifier or the forwarding device identifier does not match the device identifier of the upstream network device that is directly connected with the first network device, it is determined that the message was not intended for the network device. In these scenarios, the forwarding unit 110 may determine not to further process (e.g., decode) the message at the first network device. The forwarding unit 110 may also determine not forward the message in the communication network and may discard the message. From block 512, the flow ends.

At block 514, it is determined whether the central coordinator previously forwarded the message. After determining to forward the message in the communication network (e.g., the “yes” path from block 508 or block 510), the forwarding unit 110 of the first network device may determine whether the central coordinator received (or generated) the message. For this, the forwarding unit 110 may determine an indicator in the downstream field of the received message. For example, if the downstream field includes a first indicator (e.g., DS=0), the forwarding unit 110 may determine that the central coordinator 202 has not received or generated the message. Alternatively, if the downstream field includes a second indicator (e.g., DS=1), the forwarding unit 110 may determine that the central coordinator has received or generated the message. If the central coordinator has not previously forwarded the message, the flow continues at block 516. Otherwise, if the central coordinator previously forwarded the message, the flow continues at block 518 in FIG. 6.

At block 516, an upstream network device that is directly connected with the first network device via the upstream path is identified. The forwarding table associated with the first network device typically includes one upstream path entry. The upstream path entry may include a device identifier of the central coordinator or a device identifier of an upper-level proxy network device. The device identifier may be a TEI, a network address, a MAC address, or another suitable device identifier that uniquely identifies the network device. In some embodiments, the first network device (e.g., the network device 206) may detect the central coordinator 202 and may establish a direct communication link with the central coordinator. The network device 206 may determine that it is directly connected with the central coordinator 202 via the upstream path. In this example, the central coordinator 202 may be the upstream network device for the network device 206. Therefore, the upstream path entry in the forwarding table associated with the network device 206 may include the device identifier of the central coordinator. In another embodiment, the first network device (e.g., the network device 210) may not detect the central coordinator 202 and may be unable to establish a direct communication link with the central coordinator 202. In this embodiment, the network device 210 may be a hidden network device. The network device 210 may use the network device 208 as a proxy network device for indirectly communicating with the central coordinator 202. The network device 210 may determine that it is directly connected with the proxy network device 208 via the upstream path. In this example, the proxy network device 208 may be the upstream network device for the network device 210. Therefore, the upstream path entry in the forwarding table associated with the network device 210 may include the device identifier of the proxy network device 208. The flow continues at block 526 in FIG. 6.

At block 518, it is determined whether the first network device is directly connected with a downstream network device. In one embodiment, the forwarding unit 110 may access a forwarding table associated with the network device to determine whether the first network device operates as a proxy network device for one or more hidden network devices in the communication network. Referring to the example of FIG. 2, the network device 208 may determine that it operates as a proxy network device for network devices 210 and 212. In this example, the network devices 210 and 212 may be downstream network devices that are directly connected with the network device 208. In another embodiment, if the network device is a central coordinator, the forwarding unit 110 may identify network devices that have established a direct communication link with the central coordinator. With reference to the example of FIG. 2, the central coordinator 202 may determine that it has established a direct communication link with network devices 206 and 208. In this example, the network devices 206 and 208 may be downstream network devices for the central coordinator 202. If the network device is directly connected with a downstream network device, the flow continues at block 520. If the network device is not directly connected with a downstream network device, then the network device is a “leaf node” or “end node” in the communication network. The network device may process the message but may not re-transmit the message in the communication network. If the network device is not directly connected with a downstream network device, the flow ends.

At block 520, a downstream network device that is directly connected with the first network device is identified. The forwarding table associated with the first network device may include a downstream path entry for each downstream network device that is directly connected with the network device. Each downstream path entry may include a device identifier, such as a terminal equipment identifier (TEI), a network address, a MAC address, etc. of the corresponding downstream network device. In some embodiments, the first network device (e.g., the network device 208) may operate as a proxy network device for hidden network devices 210 and 212. In this embodiment, the forwarding table associated with the network device 208 may include a first downstream path entry associated with the network device 210 and a second downstream path entry associated with the network device 212. The first downstream path entry may include a device identifier of the network device 210; while the second downstream path entry may include a device identifier of the network device 212. In another embodiment, the first network device may be the central coordinator of the communication network. In this embodiment, the forwarding table associated with the first network device may include a downstream path entry for each network device that is directly connected with the central coordinator. In the example of FIG. 2, the forwarding table associated with the central coordinator 202 may include a first downstream path entry associated with the network device 206 and a second downstream path entry associated with the network device 208. The flow continues at block 522.

At block 522, it is determined whether the downstream network device originally transmitted the message to the first network device. The forwarding unit 110 may compare the source identifier (e.g., STEI) included in the message against the device identifier of the downstream network device indicated in the forwarding table. For example, after receiving the message 214D from the central coordinator 202, the network device 208 may compare the source identifier included in the message 214D against the device identifier of the downstream network devices 210 and 212. If the source identifier included in the message 214D matches the device identifier of the downstream network device 210, the network device 208 may determine that the downstream network device 210 generated the message. By determining whether the downstream network device generated or initially transmitted the message in the communication network, the probability of duplicate retransmissions may be minimized. If the downstream network device originally transmitted the message, the flow continues at block 524. If the downstream network device did not transmit the message to the network device, the flow continues at block 526.

At block 524, it is determined whether to re-transmit the message to other downstream network devices that are directly connected with the network device. As described above with reference to the example of FIG. 2, the network device 208 may compare the source identifier in the received message 214D against the device identifier associated with each of the downstream network devices 210 and 212. The source identifier and the device identifier may each be a MAC address, a TEI, a network address, or another suitable identifier that uniquely identifies a network device. If determined that the source identifier in the message 214D matches the device identifier of the downstream network device 210, the network device 208 may not re-transmit the message to the downstream network device 210. The network device 208 may then determine whether there are additional downstream network devices that are directly connected with the network device 208. In this example, the network device 208 may determine to re-transmit the message to the downstream network device 212. If it is determined to re-transmit the message to other downstream network devices, the flow continues at block 526. Otherwise, if there are no additional downstream network devices, the flow ends.

At block 526, it is determined whether the message was previously transmitted in the communication network. Various sub-fields in the frame control field of the message may be used to indicate whether the message was previously forwarded in the communication network. In one example as described above in FIG. 2, the PBB and BLE fields may be used to indicate that the message (e.g., the broadcast message or the multicast message) was previously forwarded in the communication network. The PBB field may include a predefined value to indicate that the message was previously forwarded in the communication network. The BLE field may include the device identifier associated with the network device that forwarded the message in the communication network, thus indicating that the message was previously forwarded in the communication network. In the example of FIG. 2, the message 214B does not include the predefined value in the PBB field (e.g., PBB≠0xFF) and does not include the device identifier of the transmitting network device 210 in the BLE field (e.g., BLE≠HSTA-1). Accordingly, the network device 208 may determine that the network device 210 was the initial network device in the PLC network 200 to transmit the message and that the message was not previously forwarded in the PLC network 200. As another example, the message 214D includes the predefined value in the PBB field (e.g., PBB=0xFF) and includes the device identifier of the central coordinator 202 in the BLE field (e.g., BLE=CCo). Accordingly, the network device 206 may determine that the central coordinator 202 was not the initial network device to transmit the message and that the message was previously forwarded in the PLC network 200. The flow continues at block 528.

At block 528, the first network device updates at least one field in the message to indicate whether the message was previously transmitted in the communication network. In some embodiments, the forwarding unit may include a first predefined value in a first frame control field to indicate that the message was previously transmitted in the communication network. The forwarding unit may also include the device identifier of the first network device in a second frame control field to indicate that the message was previously transmitted (e.g., by another network device) in the communication network. Referring to the example of FIG. 2, the network device 208 updates one or more fields of the received message 214B to form message 214C. To form the message 214C, the network device 208 may include the predefined value in the first frame control field (e.g., PBB=0xFF) to indicate that the message 214C was previously transmitted in the PLC network 200. Additionally, the network device 208 may include its device identifier in the second frame control field (e.g., BLE=PCo-1) to indicate that the network device 208 is re-transmitting (or forwarding) the message in the PLC network 200.

In other embodiments, if the message was not previously transmitted in the communication network, the forwarding unit may not include the first predefined value in the first frame control field and may not include the device identifier of the first network device in the second frame control field. Referring to the example of FIG. 2, the network device 210 receives the message 214A from the Ethernet 220 for forwarding in the PLC network 200. The network device 210 updates one or more fields of the received message 214A to form the message 214B. To generate the message 214B, the network device 210 may include a second predefined value in the first frame control field (e.g., PBB≠0xFF) to indicate that the message 214B was not previously transmitted in the PLC network 200. Additionally, the network device 210 may not include its device identifier in the second frame control field (e.g., BLE≠HSTA-1). This can indicate that the network device 210 is the initial network device in the PLC network 200 to transmit the message 214B and that the message 214B was not previously transmitted in the PLC network 200. The flow continues at block 530.

At block 530, the message is transmitted to the identified network device in the communication network. The forwarding unit 110 may transmit the message including the updated information in the frame control field (described above) to one or more network devices via the upstream path or the downstream path of the communication network. From block 530, the flow ends.

It should be understood that FIGS. 1-6 are examples meant to aid in understanding embodiments and should not be used to limit embodiments or limit scope of the claims. Embodiments may comprise additional components, different components, and/or may perform additional operations, fewer operations, operations in a different order, operations in parallel, and some operations differently. Although examples describe operations for re-transmitting a broadcast message in a communication network, embodiments are not so limited. In other embodiments, a network device may execute similar operations to re-transmit a multicast message in the communication network.

In some embodiments, as described in the Figures, a network device may first check the downstream field, determine whether to forward the message via the upstream path or the downstream path, and then compare a device identifier in the message against the device identifier of an additional network device that is directly connected with the network device. In other embodiments, the network device may first compare the device identifier in the message against the device identifier of each additional network device that is directly connected with the network device. If there is a match, the network device may determine whether to forward the message via the upstream path or the downstream path. Otherwise, the network device may discard the message.

Although examples refer to using the downstream field, the BLE field, the PBB field, and/or the STEI field to determine whether and how to forward a message (e.g., a broadcast message or a multicast message) in the communication network, embodiments are not so limited. In other embodiments, the network devices may use other suitable fields to determine whether and how to forward the message. Additionally, although Figures provide example values of the first frame control field, the second frame control field, and the downstream field, embodiments are not so limited. In other embodiments, the network device may be configured to include other suitable values in other suitable fields of the message to indicate whether the message was previously forwarded in the communication network, whether a network device is an initial network device to transmit the message in the communication network, whether the central coordinator has received the message, and so on.

As will be appreciated by one skilled in the art, aspects of the present inventive subject matter may be embodied as a system, method, or computer program product. Accordingly, aspects of the present inventive subject matter may take the form of an entirely hardware embodiment, a software embodiment (including firmware, resident software, micro-code, etc.) or an embodiment combining software and hardware aspects that may all generally be referred to herein as a “circuit,” “module” or “system.” Furthermore, aspects of the present inventive subject matter may take the form of a computer program product embodied in one or more computer readable medium(s) having computer readable program code embodied thereon.

Any combination of one or more non-transitory computer readable medium(s) may be utilized. Non-transitory computer-readable media comprise all computer-readable media, with the sole exception being a transitory, propagating signal. The non-transitory computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code embodied on a computer readable medium for carrying out operations for aspects of the present inventive subject matter may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present inventive subject matter are described with reference to flowchart illustrations and/or block diagrams of methods, apparatus (systems) and computer program products according to embodiments of the inventive subject matter. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

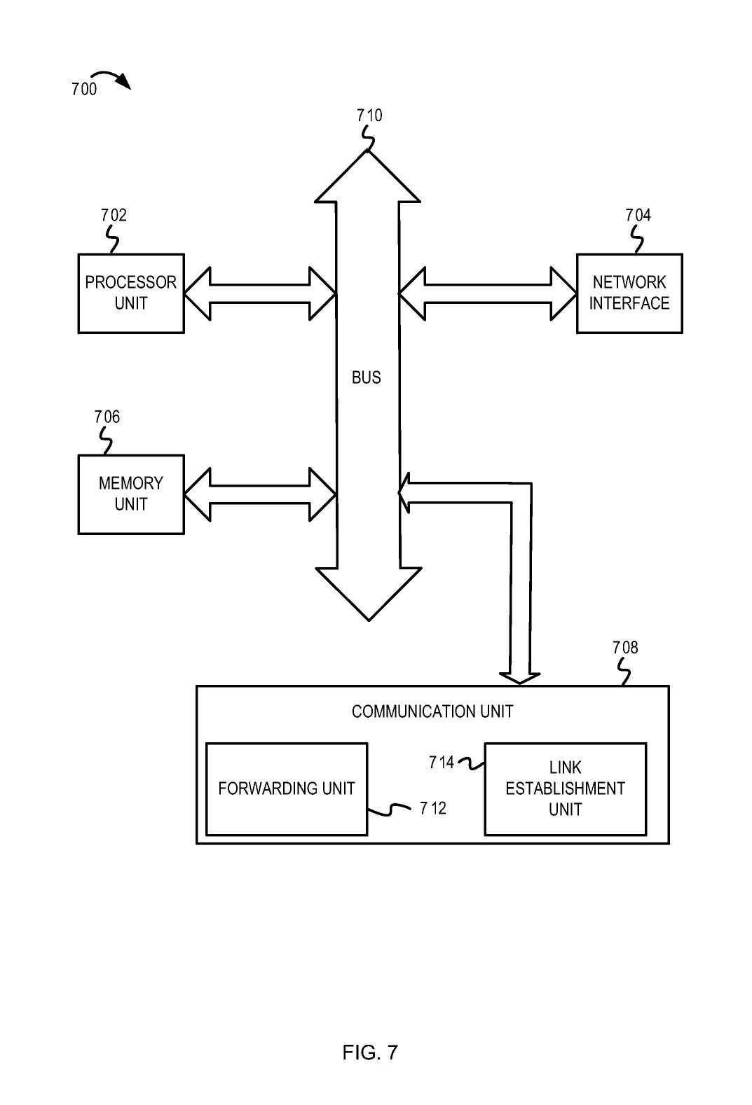

FIG. 7 is a block diagram of one embodiment of an electronic device 700 including a mechanism for forwarding messages in a communication network. In some implementations, the electronic device 700 may be a standalone or dedicated powerline communication (PLC) device connected in a powerline environment. In another embodiment, the electronic device 700 can be one of a desktop computer, laptop computer, a tablet computer, a smart appliance, a gaming console, a television, a set top box, a media player, a wearable device, or another electronic device including powerline communication capabilities. The electronic device 700 includes a processor unit 702 (possibly including multiple processors, multiple cores, multiple nodes, and/or implementing multi-threading, etc.). The electronic device 700 includes a memory unit 706. The memory unit 706 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of non-transitory machine-readable storage media. The electronic device 700 also includes a bus 710 (e.g., PCI, ISA, PCI-Express, HyperTransport®, InfiniBand®, NuBus, AHB, AXI, etc.). The electronic device 700 also includes a network interface 704 that includes a wireless network interface (e.g., a WLAN interface, a Bluetooth® interface, a WiMAX interface, a ZigBee® interface, a Wireless USB interface, etc.) and/or a wired network interface (e.g., a PLC interface, an Ethernet interface, etc.). Furthermore, in some embodiments, the electronic device 700 can execute an IEEE Std. 1905.1 protocol for implementing hybrid communication functionality.

The electronic device 700 also includes a communication unit 708. The communication unit 708 includes a forwarding unit 712 and a link establishment unit 714. The link establishment unit 714 can establish a communication link between the electronic device 700 and an upstream network device and/or a downstream network device of the communication network. In response to receiving a message for forwarding in the communication network, the forwarding unit 712 can determine whether a central coordinator has previously received the message based, at least in part, on an indicator in a predefined field of the received message. Depending on whether the central coordinator has previously received (or generated) the message, the forwarding unit 712 can determine whether to re-transmit the message to an upstream network device or a downstream network device that is directly connected to the electronic device 700, as described above with reference to FIGS. 1-6. In some embodiments, the forwarding unit 712 may compare a source identifier and/or a forwarding device identifier in the received message against a device identifier of each downstream network device that is directly connected with the electronic device to determine whether to re-transmit the message or discard the message. In some embodiments, the forwarding unit 712 may compare the source identifier and/or the forwarding device identifier against a device identifier of an upstream network device that is directly connected with the electronic device to determine whether to re-transmit the message or discard the message.

Any one of these functionalities may be partially (or entirely) implemented in hardware and/or on the processor unit 702. For example, the functionality may be implemented with an application specific integrated circuit, in logic implemented in the processor unit 702, in a co-processor on a peripheral device or card, etc. In some embodiments, the communication unit 708 can each be implemented on a system-on-a-chip (SoC), an application specific integrated circuit (ASIC), or another suitable integrated circuit to enable communications of the electronic device 700. In some embodiments, the communication unit 708 may include additional processors and memory, and may be implemented in one or more integrated circuits on one or more circuit boards of the electronic device 700. Further, realizations may include fewer or additional components not illustrated in FIG. 7 (e.g., video cards, audio cards, additional network interfaces, peripheral devices, etc.). For example, in addition to the processor unit 702 coupled with the bus 710, the communication unit 708 may include at least one additional processor unit. As another example, although illustrated as being coupled to the bus 710, the memory unit 706 may be coupled to the processor unit 702

While the embodiments are described with reference to various implementations and exploitations, it will be understood that these embodiments are illustrative and that the scope of the inventive subject matter is not limited to them. In general, techniques for forwarding messages in a communication network as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. A method comprising:
receiving a message at a first network device for forwarding in a first communication network;
determining whether to forward the message based, at least in part, on a first predefined field in the message; and
in response to determining to forward the message, determining whether to forward the message via an upstream path or a downstream path with respect to a central coordinator in the first communication network based, at least in part, on a second predefined field in the message, wherein the second predefined field indicates whether the central coordinator has previously forwarded the message.

2. The method of claim 1, wherein said determining whether to forward the message via the upstream path or the downstream path comprises:
determining to forward the message via the downstream path in the first communication network in response to determining that the second predefined field includes a first indicator; and
determining to forward the message via the upstream path in the first communication network in response to determining that the second predefined field includes a second indicator.

3. The method of claim 2, wherein,
the first indicator indicates that the central coordinator previously received the message from a second network device of the first communication network, or
the first indicator indicates that the central coordinator generated the message.

4. The method of claim 2, wherein,
the second indicator indicates that the central coordinator has not received the message from a second network device of the first communication network, or
the second indicator indicates that the central coordinator did not generate the message.

5. The method of claim 1, wherein determining whether to forward the message from the first network device comprises:
comparing a first device identifier in the first predefined field against a second device identifier associated with a second network device that is directly connected with the first network device;
determining to forward the message in the first communication network in response to determining that the first device identifier in the first predefined field matches the second device identifier associated with the second network device; and
discarding the message at the first network device in response to determining that the first device identifier in the first predefined field does not match the second device identifier associated with the second network device.

6. The method of claim 5, wherein in response to determining that the first device identifier in the first predefined field matches the second device identifier associated with the second network device, the method further comprises:
determining to transmit the message via the downstream path of the first communication network in response to determining that the second predefined field includes a first indicator; and
determining to transmit the message via the upstream path of the first communication network in response to determining that the second predefined field includes a second indicator.

7. The method of claim 1, wherein in response to determining to transmit the message via the upstream path of the first communication network, the method further comprises:
transmitting the message from the first network device to a proxy network device associated with the first network device, wherein the proxy network device is configured to forward the message to the central coordinator; or
transmitting the message from the first network device directly to the central coordinator.

8. The method of claim 1, wherein in response to determining to transmit the message via the downstream path of the first communication network, the method further comprises:
determining that the first network device is a proxy network device for a second network device of the first communication network; and
determining whether the second network device generated the message based, at least in part, on comparing a device identifier associated with the second network device and a source identifier included in the message.

9. The method of claim 8, further comprising:
transmitting the message from the first network device to the second network device in response to determining that the second network device did not generate the message; and
determining not to transmit the message to the second network device in response to determining that the second network device generated the message.

10. The method of claim 1, wherein, in response to receiving the message at the first network device from a second network device of the first communication network, the method further comprises:
prior to transmitting the message from the first network device to a third network device in the first communication network,
updating the first predefined field of the message to include a device identifier associated with the first network device; and
updating a third predefined field of the message to indicate that the message was previously forwarded in the first communication network.

11. The method of claim 1, wherein, in response to receiving the message at the first network device from a second network device of a second communication network, the method further comprises:
prior to transmitting the message from the first network device to a third network device in the first communication network,
updating the first predefined field of the message to include a predetermined value that is different from a device identifier associated with the first network device; and
updating a third predefined field of the message to indicate that the message was not previously forwarded in the first communication network.

12. The method of claim 1, wherein said receiving the message at the first network device for forwarding in the first communication network comprises one of:
receiving the message at the first network device from a second network device of the first communication network;
receiving the message at the first network device from a third network device of a second communication network; or
generating the message at the first network device.

13. A method comprising:
receiving a message at a central coordinator of a communication network for forwarding in the communication network;
determining whether to forward the message in the communication network based, at least in part, on a first predefined field in the message;
in response to determining to forward the message,
updating a second predefined field to include a first indicator in the message to indicate that central coordinator received the message; and
transmitting the message including the first indicator to a first network device that is directly connected with the central coordinator.

14. The method of claim 13, wherein said determining whether to forward the message comprises:
comparing a first device identifier in the first predefined field against a second device identifier associated with a downstream network device, wherein the downstream network device is directly connected with the first network device via a downstream path of the communication network;
determining to forward the message in response to determining that the first device identifier in the first predefined field matches the second device identifier associated with the downstream network device; and
discarding the message at the central coordinator in response to determining that the first device identifier in the first predefined field does not match the second device identifier associated with the downstream network device.

15. The method of claim 13, further comprising:
identifying a plurality of network devices of the communication network that established a direct communication link with the central coordinator;
wherein said transmitting the message including the first indicator to the first network device comprises transmitting the message including the first indicator to the plurality of network devices that established the direct communication link with the central coordinator.

16. The method of claim 13, wherein receiving the message at the central coordinator for forwarding in the communication network comprises one of:
receiving the message at the central coordinator from a second network device of the communication network;
receiving the message at the central coordinator from a third network device of another communication network; or
generating the message at the central coordinator.

17. A first network device comprising:
a processor; and
a communication unit coupled with the processor, the communication unit configured to:
receive a message for forwarding in a first communication network;
determine whether to forward the message based, at least in part, on a first predefined field in the message; and
in response to determining to forward the message, determine whether to forward the message via an upstream path or a downstream path with respect to a central coordinator in the first communication network based, at least in part, on a second predefined field in the message, wherein the second predefined field indicates whether the central coordinator has previously forwarded the message.

18. The first network device of claim 17, wherein the communication unit configured to determine whether to forward the message via the upstream path or the downstream path comprises the communication unit configured to:
forward the message via the downstream path in the first communication network in response to determining that the second predefined field includes a first indicator; and
forward the message via the upstream path in the first communication network in response to determining that the second predefined field includes a second indicator.

19. The first network device of claim 18, wherein,
the first indicator indicates that the central coordinator previously received the message from an additional network device of the first communication network; and
the second indicator indicates that the central coordinator has not received the message from an additional network device of the first communication network.

20. The first network device of claim 17, wherein the communication unit configured to determine whether to forward the message comprises the communication unit configured to:
compare a first device identifier in the first predefined field against a second device identifier associated with a second network device that is directly connected with the first network device;
determine to forward the message in the first communication network in response to determining that the first device identifier in the first predefined field matches the second device identifier associated with the second network device; and
discard the message at the first network device in response to determining that the first device identifier in the first predefined field does not match the second device identifier associated with the second network device.

21. The first network device of claim 17, wherein in response to determining to transmit the message via the upstream path of the first communication network, the communication unit is further configured to:
transmit the message from the first network device to a proxy network device associated with the first network device, wherein the proxy network device is configured to forward the message to the central coordinator; or
transmit the message from the first network device directly to the central coordinator.

22. The first network device of claim 17, wherein in response to determining to transmit the message via the downstream path of the first communication network, the communication unit is further configured to:
determine that the first network device is a proxy network device for a second network device of the first communication network; and
determine whether the second network device generated the message based, at least in part, on comparing a device identifier associated with the second network device and a source identifier included in the message.

23. The first network device of claim 22, wherein the communication unit is further configured to:
transmit the message from the first network device to the second network device in response to determining that the second network device did not generate the message; and
determine not to transmit the message to the second network device in response to determining that the second network device generated the message.

24. The first network device of claim 17, wherein, in response to receiving the message at the first network device from a second network device of the first communication network, the communication unit is further configured to:
prior to transmitting the message from the first network device to a third network device in the first communication network,
update the first predefined field of the message to include a device identifier associated with the first network device; and
update a third predefined field of the message to indicate that the message was previously forwarded in the first communication network.

25. The first network device of claim 17, wherein, in response to receiving the message at the first network device from a second network device of a second communication network, the communication unit is further configured to:
prior to transmitting the message from the first network device to a third network device in the first communication network,
updating the first predefined field of the message to include a predetermined value that is different from a device identifier associated with the first network device; and
updating a third predefined field of the message to indicate that the message was not previously forwarded in the first communication network.

26. A non-transitory machine-readable storage medium having machine executable instructions stored therein, the machine executable instructions comprising instructions to:
receive a message at a first network device for forwarding in a communication network;
determine whether to forward the message based, at least in part, on a first predefined field in the message; and
in response to determining to forward the message, determine whether to forward the message via an upstream path or a downstream path with respect to a central coordinator in the communication network based, at least in part, on a second predefined field in the message, wherein the second predefined field indicates whether the central coordinator has previously forwarded the message.

27. The non-transitory machine-readable storage medium of claim 26, wherein said instructions to determine whether to forward the message via the upstream path or the downstream path comprise instructions to:
forward the message via the downstream path in the communication network in response to determining that the second predefined field includes a first indicator, wherein the first indicator indicates that the central coordinator previously forwarded the message; and
forward the message via the upstream path in the communication network in response to determining that the second predefined field includes a second indicator, wherein the second indicator indicates that the central coordinator has not previously forwarded the message.

28. The non-transitory machine-readable storage medium of claim 26, wherein said instructions to determine whether to forward the message comprise instructions to:
compare a first device identifier in the first predefined field against a second device identifier associated with a second network device that is directly connected with the first network device;
determine to forward the message in the communication network in response to determining that the first device identifier in the first predefined field matches the second device identifier associated with the second network device; and
discard the message at the first network device in response to determining that the first device identifier in the first predefined field does not match the second device identifier associated with the second network device.

29. The non-transitory machine-readable storage medium of claim 26, wherein in response to determining to transmit the message via the upstream path of the communication network, said instructions comprise instructions to:
transmit the message from the first network device to a proxy network device associated with the first network device, wherein the proxy network device is configured to forward the message to the central coordinator; or transmit the message from the first network device directly to the central coordinator.

30. The non-transitory machine-readable storage medium of claim 26, wherein in response to determining to transmit the message via the downstream path of the communication network, said instructions comprise instructions to:
determine that the first network device is a proxy network device for a second network device of the communication network;
transmit the message from the first network device to the second network device in response to determining that a device identifier associated with the second network device does not match a source identifier included in the message; and
determine not to transmit the message to the second network device in response to determining that the device identifier associated with the second network device matches the source identifier included in the message.
